(19) United States
(12) Patent Application Publication
(10) Pub. No.: US 2006/0254722 A1
(43) Pub. Date: Nov. 16, 2006

(54) Apparatus and method for removing adhesive labels from garment hangers

(76) Inventor: Mario Mainetti, Vicenza (IT)

Correspondence Address: Zilka-Kotab, PC, P.O. BOX 721120, SAN JOSE, CA, 95172-1120, US

(21) Appl. No.: 10/501,283

(22) PCT Filed: Jan. 15, 2003
(86) PCT No.: PCT/GB03/00148

§ 371 Date: Jun. 5, 2006

(30) Foreign Application Priority Data
Jan. 15, 2002 (IT) UD2002A000005
Jan. 30, 2002 (GB) 0202043.6

(51) Int. Cl. B29C 63/00; B08B 3/02

(52) U.S. Cl. 156/584; 156/344

(57) ABSTRACT

An apparatus (1) for removing adhesive labels from garment hangers includes an input conveyer (2) for receiving garment hangers (not shown) and which terminates in a loading station (3) for loading the hangers onto a rotatable support (4). The support (4) faces a washing station (5), a pre-drying station (6) and an unloading station (7) for unloading hangers from the support (4) onto an output conveyer (8) which passes through an elongate drying chamber (9). The washing station (5) includes four water guns (not shown), each of which directs a thin high pressure and high temperature jet of water at the label area of a hanger in an up and down or side to side motion. The high temperature of the water causes the adhesive of the labels to melt, and the force of the spray removes the label and forces it into a collection chamber at the lower part of the washing station (5), where the water, label and adhesive residue are removed for cleaning.

The present invention relates to an apparatus and method for removing adhesive labels from garment hangers, and relates particularly, but not exclusively, to such an apparatus and method for removing adhesive labels from garment hangers to permit recycling of the hangers.

Many garment hangers for use in displaying garments for sale in retail outlets consist of a hanger body of plastics material, for supporting a garment, from which a hook of metal or plastics material for suspending the hanger extends. Indications of various sizes of garment are provided by means of labels, usually of paper, attached to the body of the hanger by means of adhesive, or by means of size markers mounted to the hook of the hanger.

A significant proportion of such hangers are recycled, and in order to enable recycling to take place, the hanger must be separated into its different constituent materials. Adhesive labels are presently removed from hanger bodies by means of a hand-held hot air gun which melts the adhesive attaching the label to the hanger body. This known method of label removal suffers from a number of disadvantages. Firstly, the use of handheld air guns is very labour intensive and makes the process very costly, especially when large numbers of hangers are to be recycled. Also, the use of hot air involves a risk of damaging the plastics material of the hanger body if the temperature or length of application of the hot air is not within carefully controlled limits.

Preferred embodiments of the present invention seek to overcome the above disadvantages of the prior art.

According to the present invention, there is provided an apparatus for removing adhesive labels from garment hangers, the apparatus comprising:

washing means adapted to direct pressurised liquid onto an adhesive label of at least one garment hanger for melting adhesive of said label and removing said label from the hanger;

loading means for transporting the or each said hanger towards said washing means;

unloading means for transporting the or each said hanger away from said washing means; and

drying means for drying the or each said hanger subsequently to removal of an adhesive label therefrom.

By directing liquid onto the adhesive label of one or more hangers, this provides the advantage that the liquid can be used to simultaneously melt the adhesive of the label and remove the label from the hanger, which makes the process is suitable for automation. This in turn provides the advantage that labels can be removed from hangers with greater efficiency and cost-effectiveness.

The loading means preferably comprises at least one rotatable shaft having a respective helical groove for engaging a hook of at least one said hanger, wherein rotation of the or each shaft about its respective longitudinal axis in use moves hangers along the or each said shaft towards said washing means.

By providing loading means having at least one rotatable shaft having a respective helical groove for engaging a hook of at least one hanger, this provides the advantage that the hangers can be easily and rapidly loaded onto the or each shaft.

At least one said rotatable shaft preferably has a respective groove-free portion for receiving at least one said hanger prior to movement of the hanger towards the washing means.

This provides the advantage of enabling hangers to be rapidly placed on the or each shaft but minimises the risk of the hangers becoming tangled.

In a preferred embodiment, the depth of at least one said groove increases in use in a direction towards said washing means.

This provides the advantage of enabling successive hangers on a shaft to be separated prior to washing thereof.

The washing means may comprise spraying means for directing at least one stream of liquid at elevated temperature onto an adhesive label of at least one hanger.

The spraying means is preferably adapted to direct at least one said stream in a side-to-side and/or up and down motion.

This provides the advantage of assisting in removing the labels from the hangers.

The apparatus may further comprise recycling means for recycling said liquid subsequently to spraying thereof onto at least one hanger.

The unloading means may comprise at least one rotatable shaft having a respective helical groove for engaging a hook of at least one said hanger, wherein rotation of the or each shaft about its respective longitudinal axis in use moves hangers along the or each said shaft away from said washing means.

The drying means may at least partially surround said unloading means.

The drying means may comprise an elongate chamber for drying at lease one said hanger.

In a preferred embodiment, the apparatus further comprises further drying means for at least partially drying at least one hanger subsequently to washing thereof and prior to transport thereof by said unloading means.

This provides the advantage of removing the bulk of the liquid from the hanger subsequently to washing, so that the time a hanger spends adjacent the drying means can be minimised.

The apparatus may further comprise support means for supporting a hanger during washing thereof by said washing means.

The support means may comprise a rotary support member for supporting at least one hanger and adapted to rotate to move the or each said hanger from a position facing said loading means to a position facing said washing means and/or from a position facing said washing means to a position facing said unloading means.

The apparatus may further comprise locking means for locking at least one said hanger in position on said rotary member.

The locking means may comprise at least one hook receiving member for receiving a respective hook of a hanger, and is adapted to lock at least one hanger in position on said rotary member in response to receiving a hook on at least one said hook receiving member.

A preferred embodiment of the invention will now be described, by way of example only and not in any limitative sense, with reference to the accompanying drawings in which:

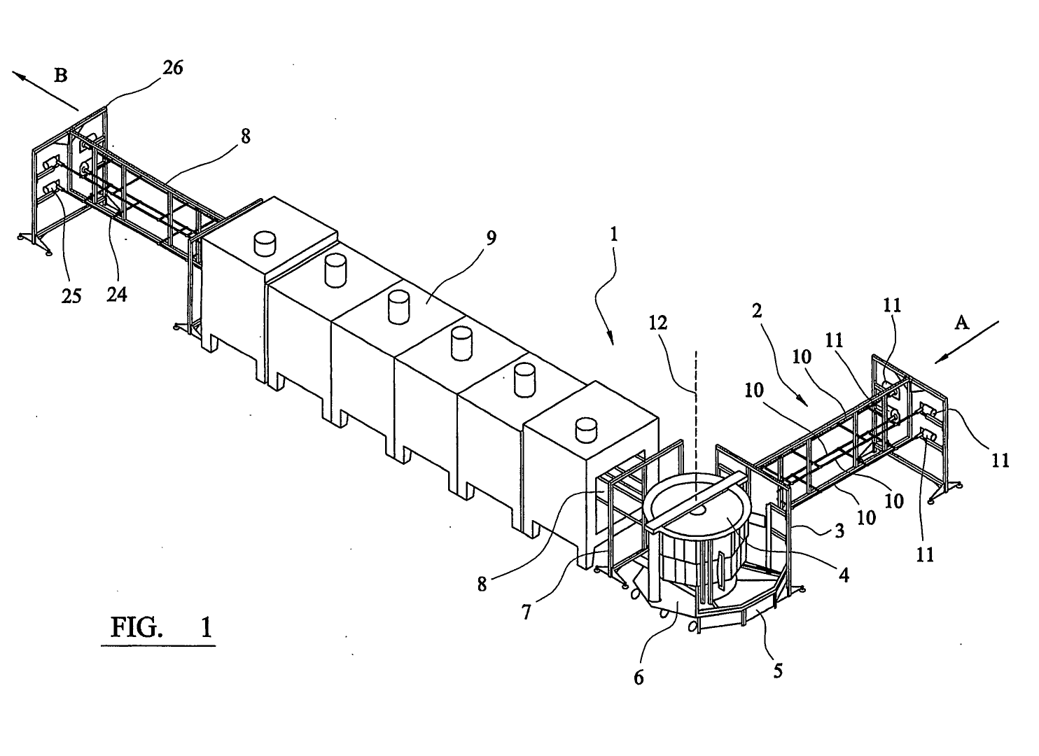

FIG. 1 is a schematic perspective view of a label removal apparatus embodying the present invention;

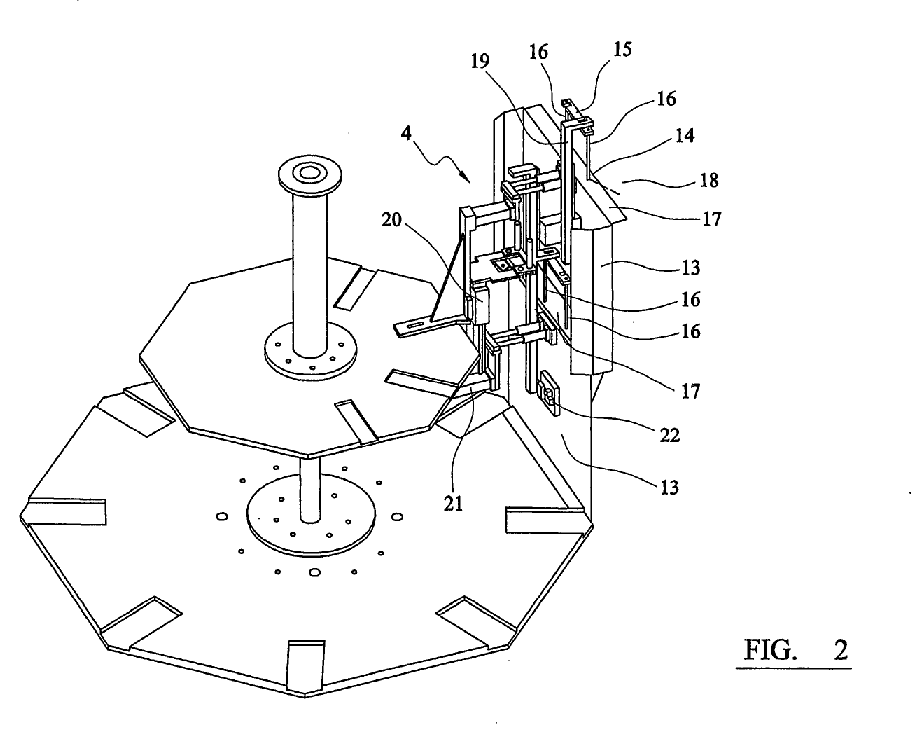

FIG. 2 is a schematic perspective view from inside of a rotary support means of the apparatus of FIG. 1; and

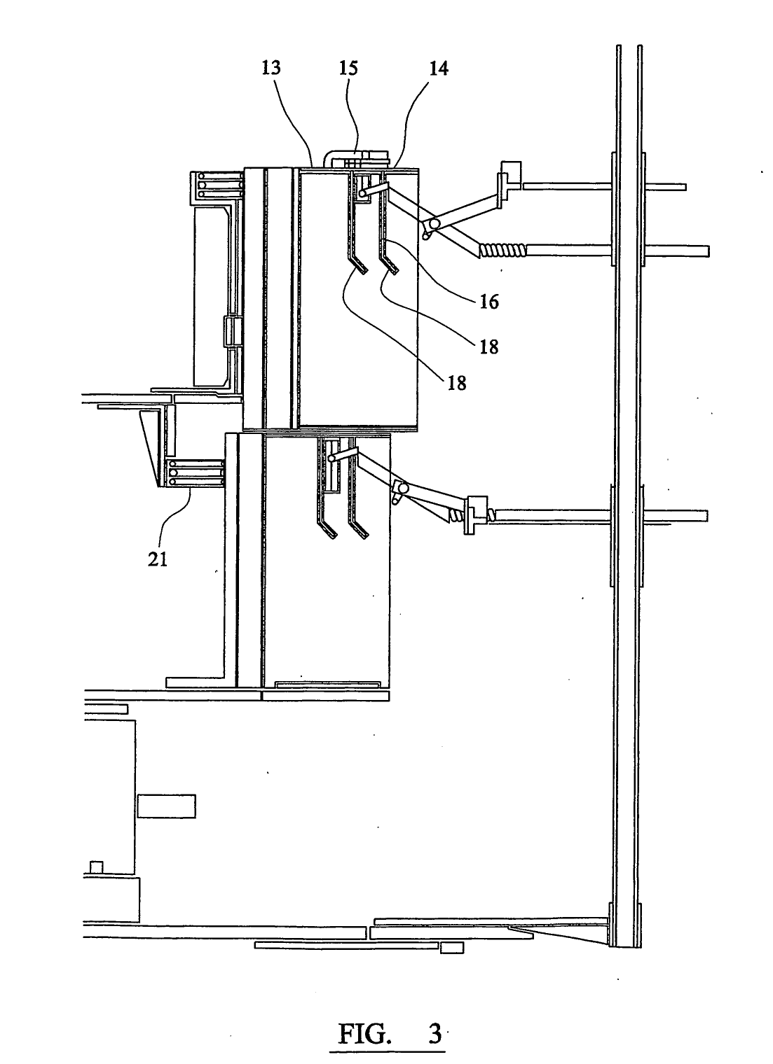

FIG. 3 is a schematic perspective view from outside of the rotary support means of FIG. 2.

Referring to FIG. 1, an apparatus 1 for removing adhesive labels from garment hangers includes and input conveyer 2 for receiving garment hangers (not shown) and which terminates in a loading station 3 for loading the hangers onto a rotatable support 4. The support 4 faces a washing station 5, a pre-drying station 6 and an unloading station 7 for unloading hangers from the support 4 onto an output conveyer 8 which passes through an elongate drying chamber 9.

The input conveyor 4 includes four rotatable shafts 10 adapted to be rotated about their longitudinal axis by means of respective motors 11. The shafts 10 are each provided with three sections. The first section, at the end of the shaft 10 remote from the loading station 3, is flat and free of grooves, so that hangers can be rapidly placed on the shaft 10 without becoming tangled. The second section, which extends from the first section, has a helical groove (not shown) for receiving a hook of a garment hanger, so that the hangers on the shaft 10 separate as their hooks engage the groove. The third section, at the end of the shaft 10 nearest to the loading station 3, has a deeper groove and separates the hangers further as they are transported in the direction of arrow A along the shafts 10.

At loading station 3, the hangers are fed from the ends of shafts 10 onto the support 4, which is rotatable about axis 12. Referring to FIG. 2, which shows in greater detail that part of the rotatable support 4 which faces the loading station 3, the support 4 is generally octagonal in external shape, and includes eight pairs of hanger receiving plates 13 (only one pair being shown in FIG. 2), the plates 13 of each pair being located one on top of the other Each of the plates 13 is provided with a rod 14 on which the hook of a hanger is received from the end of a shaft 10 at the receiving station 3. A clamp 15 has a pair of arms 16 which are slidable in corresponding apertures in an upper flange 17 of the corresponding plate 13, and each of the arms 16 is provided with an angled end portion 18 which rests on an upper part of the body of the hanger to hold the hanger in position against the plate 13 when the arms 16 are urged downwardly relative to the flange 17. The angled end portions 18 are arranged to hold a hanger in position against the corresponding plate 13 regardless of the shape or size of the hanger. The two clamps 15 are connected to each other by means of a frame 19 which is urged downwardly relative to the plates 13 by means of a cylinder 20 and held in the lower position by means of a cylinder 21 which engages a lock 22. The cylinder 20 is activated by means of the rods 14, so that the clamps 15 are automatically activated as the hangers are hung on the corresponding rods 14. Each of the plates 13 is also provided with a piston 23 for urging a plate (not shown) outwards to remove a hanger from the plate 13. The function of the pistons 23 will be explained in greater detail below.

The support 4 is arranged such that two adjacent pairs of plates 13 face the loading station 3. The hangers facing loading station 3 are then transferred to washing station 5 by rotation of the support 4 through 90 degrees about axis 12. At the same time, four further hangers are loaded onto the support 4 at loading station 3.

The washing station 5 includes four water guns (not shown), each of which directs a thin high pressure and high temperature jet of water at the label area of a hanger in an up and down or side to side motion. The high temperature of the water causes the adhesive of the labels to melt, and the force of the spray removes the label and forces it into a collection chamber at the lower part of the washing station 5, where the water, label and adhesive residue are removed for cleaning. The water cleaning is carried out by means of a water purification system, which enables the water to be reused after cleaning. It has been found that the pressure of the water from the water guns should not exceed 120 bar, and the water is applied for about 2 seconds at a temperature of approximately 80° Celsius. Temperatures higher than this should be avoided to minimise the risk of warping of the plastic material of the hangers.

By rotation of the support 4 through a further 90° about axis 12, the four hangers facing the washing station 5 are then brought into a position in which they face pre-drying station 6, which delivers a short blast of high pressure air to remove the majority of the water from washing station 5 from the hangers. Again, with each rotation of the support 4 through 90°, four further hangers are loaded onto the support 4 at loading station 3.

By rotation of support 4 through a further 90°, the hangers are brought to unloading station 7. At the unloading station 7, which is very similar in construction to the loading station 3, pistons 23 are activated to eject the four hangers from the two pairs of adjacent plates 13 facing the unloading station 7, which causes the hangers to be loaded onto four rotatable shafts 24 of unloading conveyer 8. The rotatable shafts 24 of the unloading conveyor 8 are similar in construction to the rotatable shafts 10 of loading conveyor 2, each shaft 24 being rotatable about its longitudinal axis by means of a motor 25. The drying station 9 consists of a tunnel about 6 metres long operating at a temperature of 70° C.

The operation of the apparatus will now be described.

Hangers to recycled are loaded manually onto input conveyor 2 and are transported by the conveyor in the direction of arrow A in FIG. 1. The hangers are then loaded onto the support 4 at loading station 3, secured to the support, and the support is then rotated through 90° to bring the hangers to washing station 5. This rotation brings four further plates 13 into a position facing the loading station 3, which permits four further hangers to be loaded at loading station 3 onto the support 4. The labels are removed from the hangers at washing station 5, and the de-labelled hangers are then delivered to pre-drying station 6 by rotation of the support through a further 90° about axis 12. The majority of the water is removed at pre-drying station 6, which minimises the required power of the drying station 9, and the hangers are then delivered to unloading station 7 by rotation through a further 90°, where they are unloaded from the support 4 and transported through drying station 9 by means of unloading conveyor 8 in the direction of arrow B. At the end region 26 of unloading conveyer 8, the hangers are manually removed from shafts 24 for recycling.

It will be appreciated by persons skilled in the art that the above embodiment has been described by way of example only, and not in any limitative sense, and that various alterations and modifications are possible without departure from the scope of the invention as defined by the appended claims.

1-16. (canceled)

17. An apparatus for removing adhesive labels from garment hangers, the apparatus comprising:
at least one washing apparatus adapted to direct pressurised liquid onto an adhesive label of at least one garment hanger for melting adhesive of said label and removing said label from the hanger;
at least one loading apparatus for transporting the or each said hanger towards at least one said washing apparatus;
at least one unloading apparatus for transporting the or each said hanger away from at least one said washing apparatus; and
at least one drying apparatus for drying the or each said hanger subsequently to removal of an adhesive label therefrom.

18. An apparatus according to claim 17, wherein at least one said loading apparatus comprises at least one rotatable shaft having a respective helical groove for engaging a hook of at least one said hanger, wherein rotation of the or each shaft about its respective longitudinal axis in use moves hangers along the or each said shaft towards at least one said washing apparatus.

19. An apparatus according to claim 18, wherein at least one said rotatable shaft has a respective groove-free portion for receiving at least one said hanger prior to movement of the hanger towards at least one said washing apparatus.

20. An apparatus according to claim 18, wherein the depth of at least one said groove increases in use in a direction towards at least one said washing apparatus.

21. An apparatus according to claim 17, wherein at least one said washing apparatus comprises at least one spraying apparatus for directing at least one stream of liquid at elevated temperature onto an adhesive label of at least one hanger.

22. An apparatus according to claim 21, wherein at least one said spraying apparatus is adapted to direct at least one said stream in a side-to-side and/or up and down motion.

23. An apparatus according to claim 21, further comprising at least one recycling apparatus for recycling said liquid subsequently to spraying thereof onto at least one hanger.

24. An apparatus according to claim 17, wherein at least one said unloading apparatus comprises at least one rotatable shaft having a respective helical groove for engaging a hook of at least one said hanger, wherein rotation of the or each shaft about its respective longitudinal axis in use moves hangers along the or each said shaft away from at least one said washing device.

25. An apparatus according to claim 17, wherein at least one said drying apparatus at least partially surrounds at least one said unloading apparatus.

26. An apparatus according to claim 25, wherein at least one said drying apparatus comprises an elongate chamber for drying at least one said hanger.

27. An apparatus according to claim 17, further comprising at least one further drying apparatus for at least partially drying at least one hanger subsequently to washing thereof and prior to transport thereof by at least one said unloading apparatus.

28. An apparatus according to claim 17, further comprising at least one support for supporting a hanger during washing thereof by at least one said washing apparatus.

29. An apparatus according to claim 28, wherein at least one said support comprises a rotary support member for supporting at least one hanger and adapted to rotate to move the or each said hanger from a position facing at least one said loading apparatus to a position facing at least one said washing apparatus and/or from a position facing at least one said washing apparatus to a position facing at least one said unloading apparatus.

30. An apparatus according to claim 29, further comprising at least one locking apparatus for locking at least one said hanger in position on said rotary member.

31. An apparatus according to claim 30, wherein at least one said locking apparatus comprises at least one hook receiving member for receiving a respective hook of a hanger, and is adapted to lock at least one hanger in position on said rotary member in response to receiving a hook on at least one said hook receiving member.
